(19) United States
(12) Patent Application Publication
(10) Pub. No.: US 2024/0242621 A1
(43) Pub. Date: Jul. 18, 2024

(54) VEHICLE SIMULATION MODEL MODELING METHOD AND EXAMINATION JUDGMENT METHOD

(71) Applicants: GUILIN UNIVERSITY OF ELECTRONIC TECHNOLOGY, Guilin (CN); GUILIN UNIVERSITY OF AEROSPACE TECHNOLOGY, Guilin (CN)

(72) Inventors: Yuyuan PENG, Guilin (CN); Yubao PENG, Guilin (CN)

(21) Appl. No.: 18/517,142

(22) Filed: Nov. 22, 2023

(30) Foreign Application Priority Data
Jan. 13, 2023 (CN) 2023100650672

(51) Int. Cl. G09B 9/042; B60W 40/105

(52) U.S. Cl. CPC G09B 9/042; B60W 40/105; B60W 2710/10

(57) ABSTRACT

A vehicle simulation model modeling method includes the following steps: actual parameters of an exam vehicle are obtained, and thereby modeling based on the actual parameters of the exam vehicle to obtain a vehicle model. The vehicle model is imported into a Unity3D™ project and vehicle assemblies are added to the vehicle model. Vehicle start parameters, gear parameters, powertrain parameters, vehicle status parameters, engine parameters, and input coefficients are set for the vehicle model added with vehicle assemblies. In addition, an applydrive method and a carspeed method of Unity3D™ are simultaneously rewrite to calculate the torque and speed of the vehicle model, thereby obtaining the exam vehicle simulation model. By generating more precise models, making the results obtained from simulated exams more accurate, and achieve better simulation results.

### TECHNICAL FIELD

The disclosure relates to the technical field of vehicle simulation exams, and particularly to a vehicle simulation model modeling method and an examination judgment method.

### BACKGROUND

With the development of technology and the advancement of the internet, people can obtain a lot of information through the internet, but there is still a lot of technical knowledge that needs to be mastered through practical operation, including automotive driving technology. For the vehicle driver's license exam, although the theoretical knowledge of subject one can be learned through the internet, practical exercises for subjects two and three require training at the exam venue, which is a waste of time. Although there are many online simulation exam training devices available now, the modeling of exam vehicles and the simulation of vehicle driving are not accurate enough, and the simulation of exam venues and exam judgments are also inaccurate, resulting in many problems in actual operation even after online device training.

### SUMMARY

The disclosure aims to overcome at least one defect of the prior art mentioned above, and provides a vehicle simulation model modeling method and an examination judgment method to solve the problem of inaccurate online simulation exam training models and exam judgments.

The technical solutions adopted by the disclosure are as follows.

A vehicle simulation model modeling method includes the following steps:
S1: firstly, actual parameters of an exam vehicle are obtained, and thereby modeling based on the actual parameters of the exam vehicle to obtain a vehicle model;
S2: the vehicle model is imported into a Unity3D™ project (i.e., real time 3D development platform) and vehicle assemblies are added to the vehicle model;
S3: vehicle start parameters, gear parameters, powertrain parameters, vehicle status parameters, engine parameters, and input coefficients are set for the vehicle model added with vehicle assemblies; and
S4: an exam vehicle simulation model is obtained by setting a speed calculation method for the vehicle model according to the parameters set in step S3.

By obtaining actual parameters of the real vehicle for modeling, and setting various detailed parameters for the vehicle model in the Unity3D™ project, the established exam vehicle simulation model is more precision and the parameters obtained under the simulation of driving are more accurate.

Moreover, the vehicle assemblies in S2 include wheel colliders, ordinary colliders, and rigid body components.

The step of adding the wheel colliders includes: the wheel colliders are added to wheels of the vehicle model in the Unity3D™ project.

The step of adding the ordinary colliders includes: four spherical colliders are added for a front of the vehicle model, a rear of the vehicle model, a left of the vehicle model, and a right of the vehicle model in the Unity3D™ project, as well as a square collider is added to a body of the vehicle model in the Unity3D™ project.

The step of adding the rigid body components includes: the rigid body components are added to the vehicle model in the Unity3D™ project, and mass parameters are set based on the actual parameters of the exam vehicle. An option of a use gravity of the rigid body components is chosen.

The corresponding colliders are added to the vehicle model to simulate the vehicle, making the simulation of the vehicle model more precise. In addition, the rigid body components are added and the actual parameters of the actual vehicle are used, specifically the weight of the vehicle is used to set the value of the mass parameters, and the option of a use gravity is chosen to simulate the weight of the actual vehicle, further improving the precision of the simulation and making the parameters more accurate and realistic.

The vehicle start parameters in S3 include a power off status, a power on status, and a starting vehicle status.

And/or the gear parameters include manual gear parameters and automatic gear parameters. The manual gear parameters include a neutral gear, a first gear, a second gear, a third gear, a fourth gear, a fifth gear, and a reverse gear, the automatic gear parameters include a parking gear, a forward gear, and a reverse gear.

And/or the powertrain parameters include a maximum wheel offset angle, a transmission efficiency, a brake pedal torque, and a braking curve.

And/or the vehicle status parameters include a gear ratio of each gear, a wheel torque of each gear, a minimum speed and a maximum speed of each gear, an idle speed of each gear and a foot brake torque of each gear.

And/or the engine parameters include a maximum engine speed, a minimum engine speed, a relationship curve between an engine speed and an output power, a curve speed ratio, a torque value of the idle speed, a speed increase limit, a speed decrease limit, a downshift deceleration acceleration, a conversion coefficient from an engine to the wheel torques.

And/or the input coefficients include a steering wheel input, a clutch input, a brake input, a throttle input, and a handbrake switch.

The steps provide detailed parameters correspondence for each part that needs to be calculated, making the motion calculation of the exam vehicle more accurate and simulating the exam vehicle more realistic. The starting parameters, gear parameters, and input coefficients need to be matched with external devices, while the powertrain parameters, status parameters, and engine parameters of the exam vehicle are obtained based on the actual parameters of the real vehicle.

The speed calculation method for the vehicle model according to the parameters set in step S4 includes an applydrive method.

A current gear is one of the gear parameters. A step of applying the applydrive method includes: when a current vehicle speed is less than a minimum speed in the current gear, a current torque value of the vehicle model is calculated, followed by evenly distributing the current torque value of the vehicle model to driving wheels to obtain current forward torque values of the driving wheels, and then a vehicle rigid speed is calculated based on the current forward torque values.

The driving wheels are that actually drive the real vehicle forward.

And the vehicle rigid speed is a theoretical speed of the vehicle model.

The step of calculating the current torque value of the vehicle model includes an equation as follows: the current torque value of the vehicle model=a current torque value of an idle speed in the current gear×a current gear ratio in the current gear×the transmission efficiency×the clutch input+a current torque value of a current engine speed in the current gear×the throttle input×the clutch input×the transmission efficiency.

The current torque value of the current engine speed is obtained based on the engine parameters of the real vehicle.

The current vehicle speed is set to 0 initially and a speed of vehicle model is set to 0 when the vehicle model is not started.

In a specific calculation, the current torque value of the idle speed in the current gear, the current gear ratio in the current gear and transmission efficiency are obtained based on the actual parameters of the exam vehicle. When calculating, the specific situation of the real vehicle needs to be considered to achieve a more realistic simulation effect. The vehicle rigid speed is the theoretical speed of the vehicle model. When the vehicle is not started, the vehicle rigid speed needs to be calculated based on the torques of the wheels to obtain an initial vehicle rigid speed, and then the vehicle rigid speed can be synchronously updated as it gradually increases.

The speed calculation method for the vehicle model according to the parameters set in step S4 further includes a carspeed method.

A step of applying the carspeed method includes: normalization of the vehicle rigid speed is obtained, followed by calculating a minimum speed limit in the current gear, and an equation of the minimum speed limit is as follows: the minimum speed limit in the current gear=(a maximum speed in the current gear−a minimum speed in the current gear)×the throttle input+the idle speed in the current gear.

When the vehicle rigid speed is greater than the maximum speed in the current gear, a current speed of the vehicle model is calculated through an equation as follows: the current speed of the vehicle model=the maximum speed in the current gear×the normalization of the vehicle rigid speed; and then the vehicle rigid speed is updated as the current speed of the vehicle model.

When the vehicle rigid speed is greater than the minimum speed limit in the current gear and less than the maximum speed in the current gear, an intermediate speed as speedVal is obtained through an equation as follows: the speedVal=the vehicle rigid speed−the downshift deceleration acceleration×time; the time is an interval from a last frame to a current frame in seconds. When the speedVal is greater than 0, the equation of the current speed of the vehicle model is as follows: the current speed of the vehicle model=a value of the speedVal×the normalization of the vehicle rigid speed, followed by updating the vehicle rigid speed as the current speed of the vehicle model.

A current standardized speed of the vehicle model in the current speed is calculated through an equation as follows: the current standardized speed=the current speed×3.6, and standardizing the current speed of the vehicle to kilometer per hour (km/h). A normalization method for obtaining the vehicle rigid speed is to use the normalized method in the Unity3D™ project to normalize the vehicle rigid speed into a vector with a direction, followed by calculating the current speed of the vehicle by normalizing the vehicle rigid speed with the same direction as the vehicle rigid speed. Moreover, since the previous time calculation unit is seconds, and the vehicle speed is usually in km/h, it is necessary to standardize the current vehicle speed after calculation, the current vehicle speed unit is converted to km/h to obtain the current standardized speed of the vehicle. And in order to simulate the driving process of the vehicle, the minimum speed limit for the current gear is defined, and the calculation formula is: the minimum speed limit in the current gear=(a maximum speed in the current gear−a minimum speed in the current gear)×the throttle input+the idle speed in the current gear, that is to say, when there is no the throttle input, the vehicle rigid speed can decrease, but the vehicle rigid speed can be limited to the idle speed in the current gear due to the minimum speed limit of the current gear. When there is the throttle input, even if the vehicle model slows down and the vehicle rigid speed decrease, the vehicle rigid speed can be limited to the minimum as well, the equation of the minimum is: (a maximum speed in the current gear−a minimum speed in the current gear)×the throttle input+the idle speed in the current gear.

A vehicle simulation exam judgment method includes the following steps:
A1: an initial exam scenario model is established based on real exam scenarios and the initial exam scenario model is imported into the Unity3D™ project;
A2: the vehicle model is established based on the actual parameters of the exam vehicle by using the vehicle simulation model modeling method;
A3: rules for exam items are set based on different exam rules;
A4: rule triggers and determination rules are set for the initial exam scenario model based on the exam rules of the exam items, and followed by generating a simulated exam scenario model;
A5: the rule triggers and the determination rules of the simulated exam scenario model and the vehicle model of the exam vehicle are imported into an external vehicle simulation device system, and the vehicle model is matched with operation equipment of the exam vehicle simulation model, followed by establishing conversion rules for operation datum of the operation equipment and the simulation datum of the exam vehicle simulation model;
A6: the operation datum are input through the operation equipment by a terminal user, and followed by converting the operation datum into the simulation datum of the exam vehicle simulation model according to the conversion rules by the vehicle simulation device;
A7: the exam vehicle simulation model is driven to run in the simulated exam scenario model based on the simulation datum, and followed by judging a score based on the rule triggers and the determination rules by the vehicle simulation device.

By using real exam scenarios to establish the initial scenario model, a more realistic sense of presence and realism can be obtained. And according to the exam items, rule triggers and judgment rules are set for the initial scene model to obtain simulated exam scenario. In addition, the exam vehicle simulation model is imported to the vehicle simulation devices, such as the steering wheel and throttle, which are matched and established the conversion rules for the operation datum and simulation datum input of the operating device, such as a rotation angle of the operating device's steering wheel and the conversion rules for the steering wheels input of the exam vehicle simulation model. After establishing the rules, the operation datum are sent to the vehicle simulation device by operating the device, and then the operation datum are converted into simulation datum of the exam vehicle simulation model, to simulate driving in the simulated exam scenario model, and then data feedback from the rule triggers is analyzed during the driving process to determine the score of the terminal user based on the judgment rules. By setting various parameters in detail for the exam vehicle simulation model and setting a set of conversion rules with the vehicle simulation devices, the judgment criteria for the simulation exam are more detailed and the results obtained are more accurate.

The step for establishing an initial exam scenario model based on a real exam scenarios is as follows: the real exam scenario is sampled through an aerial modeling or oblique photography techniques to obtain sampling results, and followed by processing and optimizing the sampling results using Maya3D™ to obtain the initial exam scenario model that is consistent with an environment layout of the real exam scenarios. The initial exam scenario model is established simultaneously to consistent with the environment layout of the real exam scenarios, which makes the established model more realistic and making exam judgments more accurate.

In addition, the step of setting the rule triggers and the rule triggers are as follows:
A41: a cube plug-in component is used to build cube models in the Unity3D™ project;
A42: collider members are added to the cube models;
A43: attributes of the cube models are set as triggers in the Unity3D™ project to make the cube models form a plurality of target triggers;
A44: locations required to be judged by rules are marked in the initial exam scenario model as trigger points;
A45: the plurality of the target triggers are set at each trigger point through steps A41-A43;
A46: parameters and rules for each target trigger are set based on the rules of the exam items and the initial exam scenario model, thereby forming the rule triggers.

Further, the step of setting the plurality of the target triggers are as follows: the target triggers are set at start locations, process locations, and end locations of rule determinations at the trigger points.

One of the target triggers is set at each of the start location and the end location, and one or more of the target triggers are set at the process location.

In the simulation exam scenario model, the target triggers set at the start locations are used to determine the start of the judgment items, the target triggers set at the end locations are used to determine the end of the judgment items, and the target triggers set at the process locations are used to set specific rules, and one or more target triggers are set according to the actual situation to determine the rules, which makes the judgment more precise and further improve the judgment results.

The parameters are set for each of the target triggers, including position datum and scale datum. The position, height, and size of the target triggers can be set based on the position datum and the scale datum.

The judgment rules include preset judgment rules, the preset judgment rules include: speed limit rules, vehicle light rules, line pressing rules, and flameout rules. In addition, the judgment rules also include exam judgment rules, the exam judgment rules include rules set based on the exam items.

Compared with the prior art, the beneficial effects of the disclosure are as follows.
1. The disclosure models the exam vehicle by collecting datum, further setting various detailed parameters, and achieving more precise simulation of the exam vehicle to improve the accuracy of simulation exam.
2. The disclosure models real exam scenarios, sets rule triggers for each position that needs to be judged, and sets rule triggers for judgment based on the beginning, process, and end of the judgment. Moreover, detailed rules for judgment are set in the rule triggers of the process, further improving the accuracy of judgment.
3. The disclosure establishes the conversion rules between the operation device of the displayed vehicle simulation device and the exam vehicle simulation model, which can obtain more detailed data information of the exam vehicle model, further improving the accuracy of judgment and expanding the scope of judgment.

### BRIEF DESCRIPTION OF DRAWINGS

FIG. 1 illustrates a flowchart of steps of an embodiment 1 of the disclosure.

FIG. 2 illustrates a flowchart of steps of an embodiment 2 of the disclosure.

FIG. 3 illustrates a flowchart of steps of the embodiment 2 of the disclosure.

### DETAILED DESCRIPTION OF EMBODIMENTS

The attached drawings of the disclosure are only for illustrative purposes and cannot be understood as limiting the disclosure. In order to better illustrate the following embodiments, some components in the attached drawings may be omitted, enlarged or reduced, which does not represent the actual size of the product. For those skilled in the art, it is understandable that some well-known structures and their explanations may be omitted in the attached drawings.

### Embodiment 1

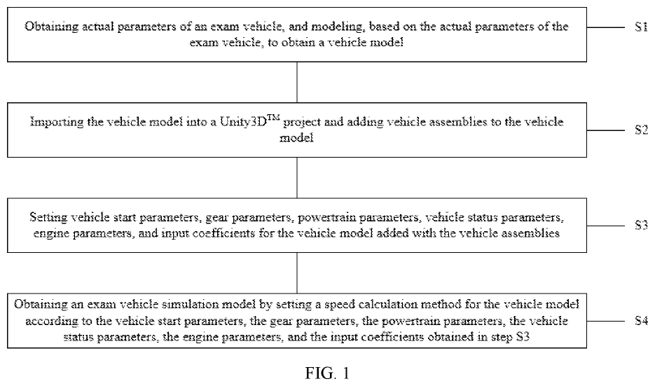

In an embodiment, as shown in FIG. 1, A vehicle simulation model modeling method includes the following steps.
S1: firstly, actual parameters of an exam vehicle are obtained, and thereby modeling based on the actual parameters of the exam vehicle to obtain a vehicle model.
S2: the vehicle model is imported into a Unity3D™ project and vehicle assemblies are added to the vehicle model.

The vehicle assemblies include wheel colliders, ordinary colliders, and rigid body components.

The step of adding the wheel colliders includes: the wheel colliders are added to wheels of the vehicle model in the Unity3D™ project, in order to achieve the effect of imitating wheel movement. In addition, adding the wheel colliders to the vehicle model also makes each vehicle wheel concretization, and specific variables and parameters can be set for the wheels by using the wheelcollider application programming interface (API) of Unity3D™, such as motortorque variable, steelangle variable, breaktorque variable, and redhat package manager (rpm) variable. The motortorque variable is the motor torque on the axle of the wheel, that is, the forward torque, used to adjust the rotation of the wheel. The steerangle is the steering angle of the wheel, used to adjust the steering of the wheel, which needs to be matched with the input. The breaktorque variable is the braking torque used for the braking of the vehicle model. The rpm variable is the speed per minute of the wheels, which can be used to calculate the speed of the vehicle model.

The step of adding the ordinary colliders includes: four spherical colliders are added for a front of the vehicle model, a rear of the vehicle model, a left of the vehicle model, and a right of the vehicle model in the Unity3D™ project, as well as a square collider is added to a body of the vehicle model in the Unity3D™ project, which adds a physical collision detection basis to the vehicle model.

The step of adding the rigid body components includes: the rigid body components are added to the vehicle model in the Unity3D™ project, and mass parameters are set based on the actual parameters of the exam vehicle, other parameters remains unchanged. An option of a use gravity of the rigid body components is chosen to simulate the weight of the vehicle, which enables the vehicle model to have better physical effects during operation, thereby achieving better simulation results.

S3: vehicle start parameters, gear parameters, powertrain parameters, vehicle status parameters, engine parameters, and input coefficients are set for the vehicle model added with vehicle assemblies.

In S3, many parameters are set for the vehicle model, the vehicle start parameters include a power off status, a power on status, and a starting vehicle status, and the process state of the starting vehicle status is used as the basis for exam judgment.

And/or the gear parameters include manual gear parameters and automatic gear parameters.

The manual gear parameters include a neutral gear, a first gear, a second gear, a third gear, a fourth gear, a fifth gear, and a reverse gear, the automatic gear parameter includes a parking gear, a forward gear, and a reverse gear.

Specifically, the parameters need to be obtained from external devices and assigned values, such as whether the external device is powered on to assign values to the power off state and power on state, whether to start the vehicle after the power is turned on to assign values to the starting vehicle status, and then the gear engagement of the external device during the start process is assigned to the corresponding gear in the manual gear parameters or the corresponding gear in the automatic gear parameters. It is should be noted that in this embodiment, the external device is any device of the prior art, which is an external simulation device with a complete simulation of vehicle operation process and supporting the Unity3D™ operating system.

And/or the powertrain parameters include a maximum wheel offset angle, a transmission efficiency, a brake pedal torque, and a braking curve. Specifically, the maximum wheel offset angle is different for each vehicle and needs to be set based on the actual parameter datum of the exam vehicle, combined with the steerangle variable, to control the steering of the vehicle. The transmission efficiency parameters mainly simulate the transmission efficiency of the actual vehicle's gearbox, so it needs to be set based on the actual parameters obtained from the exam vehicle, the brake pedal torque and the braking curve are mainly used to simulate the braking of vehicles, which need to be combined with specific inputs. However, the brake pedal torque and the braking curve are need to be set based on the actual parameter datum of the exam vehicle, and the braking curve reflects the braking capacity of the vehicle.

And/or the vehicle status parameters include gear ratio of each gear, a wheel torque of each gear, a minimum speed and a maximum speed of each gear, an idle speed and a foot brake torque of each gear.

And/or the engine parameters include a maximum engine speed, a minimum engine speed, a relationship curve between an engine speed and an output power, a curve speed ratio, a torque value of the idle speed, a speed increase limit, a speed decrease limit, a downshift deceleration acceleration, a conversion coefficient from an engine to the wheel torques. The curve speed ratio includes the power to revolutions per minute (rpm) curve and rpm ratio, as well as the power to probabilistic roadmaps (PRM) curve torque ratio. The vehicle status parameters and vehicle engine parameters are used to calculate the speed or braking situation of the vehicle model in various gears. Detailed calculation datum are used to make the results obtained from the simulated exam of the vehicle using the embodiment more realistic.

And/or the input coefficients include a steering wheel input, a clutch input, a brake input, a throttle input, and a handbrake switch.

Specifically, the terminal user operates the corresponding operating devices on external devices, such as steering wheel, clutch, and brake. The external devices convert the operations into operational datum. For ease of understanding, the operational datum are simply presented in simple numerical form, when the steering wheel rotation angle is converted to (−1, 1), the steering wheels are turned fully to the left to −1 and fully to the right to 1; the input of the clutch is converted to (0,1), the clutch is not pressed to 0, and the clutch is fully pressed to 1; the input range of the brake is converted to (0,1), the brake is not pressed to 0, and the brake is fully pressed to 1; the input of the throttle is converted to (0,1), the throttle is not pressed to 0, and the throttle is fully pressed to 1; turning off the handbrake switch to 0, and turning on the handbrake switch to 1; and matching the numerical range with the corresponding parameters in the input coefficients of the exam vehicle simulation model. In this embodiment, after receiving operation data input from the external devices, the corresponding input coefficients are obtained based on the operation datum.

After setting the parameters, the next step is proceeded:

S4: an exam vehicle simulation model is obtained by setting a speed calculation method for the vehicle model according to the parameters set in step S3.

The speed calculation method for the vehicle model according to the parameters set in step S4 includes an applydrive method and a carspeed method.

A step of applying the applydrive method includes: the current speed of the vehicle is obtained first, a current vehicle speed is initially set to 0 and a speed of vehicle model is set to 0 when the vehicle model is not started, and then compared with a minimum speed in the current gear of the vehicle model. When the current vehicle speed is less than the minimum speed in the current gear, a current torque value of the vehicle model is calculated, this situation generally occurs when the real vehicle starts or shifts gears, followed by evenly distributing the current torque value of the vehicle model to driving wheels to obtain current forward torque values of the driving wheels, the real vehicle generally includes a front wheel drive, a rear wheel drive, and a four-wheel drive, and according to the actual type of the exam vehicle, the current torque of the vehicle is evenly distributed to the specific driving wheels. When the exam vehicle is in the front wheel drive, the current torque of the vehicle is divided by 2 and allocated to the motortorque parameter of the front wheel, which is the forward torque. When the exam vehicle is in rear wheel drive, the current torque of the vehicle is divided by 2 and allocated to the forward torque of the rear wheel. When the exam vehicle is in the four-wheel drive, the current torque of the vehicle is divided by 4 and allocated to the forward torque of each wheel. Then the vehicle rigid speed is calculated based on the forward torque.

A step of calculating the current torque value of the vehicle model includes an equation as follows: the current torque value of the vehicle model=a current torque value of an idle speed in the current gear×a current gear ratio in the current gear×the transmission efficiency× the clutch input+a current torque value of a current engine speed in the current gear×the throttle input×the clutch input×the transmission efficiency.

Among the above parameters, the current torque value of the idle speed in the current gear, the current gear ratio in the current gear, and the transmission efficiency can be set based on the actual parameter data of the exam vehicle. The clutch input and the throttle input are converted from the operation datum of the external device. The current torque value of the current engine speed in the current gear needs to be calculated specifically, and the specific calculation method is as follows: the current engine speed is divided by the ratio value of the power to the speed curve rpm to obtain a result, and the result is taken into the speed to output power curve to obtain a corresponding value. Then the corresponding value is multiplied by the ratio of power to speed curve torque, and followed by multiplying by the engine to wheel torque conversion coefficient to finally obtain the current torque value of the current engine speed in the current gear. The current engine speed is 0 when the vehicle model is not started, and is assigned an initial value when the vehicle model is just started. In this embodiment, the initial value is given as 1000, and the new value is obtained through the applydrive method.

In addition, in the calculation of the current torque value of the current engine speed, when the gear parameters of the vehicle model is in the automatic gear, the value of the clutch input is fixed at 1. When the gear parameter of the vehicle model is in the manual gear, the clutch input is calculated based on the value between (0, 1) converted from the clutch pedal of the external devices.

After obtaining the current torque value of the current engine speed of the vehicle, a rotational speed of the wheels can be obtained, thereby obtaining the vehicle rigid speed.

Moreover, in the applydrive method, the brake input and handbrake switch status of the vehicle model are obtained to simulate braking. When the external device applies the foot brake, the applydrive method obtains the brake pedal torque (operating datum) of the external device's foot brake pedal to calculate the foot brake torque, the foot brake torque=the brake pedal torque×brake input, then the foot brake torque value is assigned to the braketorque parameter of each wheel collider to slow down or stop the vehicle. The handbrake switch includes two states: on and off, a maximum value of the foot brake torque is multiplied by the handbrake switch state value (0 or 1) to obtain a value, and then the value is assigned to the braketorque parameter of each wheel collider to stop the vehicle.

In the applydrive method, the steering wheel input of the vehicle model can also be obtained to simulate steering. Specifically, when the external device operates the steering wheel, the ratio of the current steering wheel rotation angle to the maximum rotation angle is multiplied by the steering wheel input to obtain a value, and the value is assigned to the steeltorque parameter of each wheel collider to achieve steering for the vehicle.

In addition to setting the applydrive method, this embodiment also sets the carspeed method, which specifically includes the following steps: normalization of the vehicle rigid speed is obtained, specifically, the normalized method is used in the Unity3D™ project. The vehicle rigid speed is normalized into a vector with a direction, followed by calculating the current speed of the vehicle by normalizing the vehicle rigid speed with the same direction as the vehicle rigid speed.

Then the minimum speed limit in the current gear is defined, which is used to limit the minimum speed of the vehicle model in the current gear during the operation, and an equation of the minimum speed limit is as follows: the minimum speed limit in the current gear=(a maximum speed in the current gear−a minimum speed in the current gear)×the throttle input+the idle speed in the current gear, the minimum speed limit in the current gear is affected by the throttle input.

When vehicle rigid speed is greater than the maximum speed in the current gear, a current speed of the vehicle model is calculated, an equation of the current speed of the vehicle model is as follows: the current speed of the vehicle model=the maximum speed in the current gear×the normalization of the vehicle rigid speed; and then the vehicle rigid speed is updated as the current speed of the vehicle model, which is equivalent to the current vehicle speed cannot exceed the maximum speed of the current gear.

When the vehicle rigid speed is greater than the minimum speed limit in the current gear and less than the maximum speed in the current gear, an intermediate speed as speedl′al is obtained, and an equation of the speedVal is as follows: the speedVal=the vehicle rigid speed−the downshift deceleration acceleration×time; the time is an interval from a last frame to a current frame in seconds. When the speedl′al is greater than 0, the equation of the current speed of the vehicle model is as follows: the current speed of the vehicle model=a value of the speedVal×the normalization of the vehicle rigid speed, followed by updating the vehicle rigid speed as the current speed of the vehicle model. According to the calculation of the applydrive method set above, when the throttle input decreases, the current torque value of the vehicle model decreases and the vehicle rigid speed decreases. That is, the speed of the vehicle model in the current gear is affected by the throttle input. Therefore, the speedVal is defined to simulate the deceleration process of the vehicle at this stage. However, when the vehicle is running, even without throttle input, the vehicle cannot stop running directly. In order to further simulate the actual operation of the vehicle, the minimum speed limit in the current gear is used to limit the minimum speed at which the vehicle model operates in the current gear, according to the calculation equation for the minimum speed limit in the current gear, when there is no throttle input, the minimum speed limit in the current gear is the idle speed in the current gear. That is, when there is no throttle input, the vehicle rigid speed can decrease, but the minimum speed can decrease to the minimum idle speed in the current gear. When there is throttle input, even if the vehicle rigid speed decreases, the minimum speed limit can only be decreased to the minimum speed limit in the current gear, and the equation of the minimum speed limit in the current gear is as follows: the minimum speed limit in the current gear=(a maximum speed in the current gear−a minimum speed in the current gear)×the throttle input+the idle speed in the current gear.

A current standardized speed of the vehicle model in the current speed is calculated through an equation as follows: the current standardized speed=the current speed×3.6, and standardizing the current speed of the vehicle to kilometer per hour (km/h). Moreover, since the previous time calculation unit is seconds, and the vehicle speed is usually in km/h, it is necessary to standardize the current vehicle speed after calculation, converting the current vehicle speed unit to km/h to obtain the current standardized speed of the vehicle.

### Embodiment 2

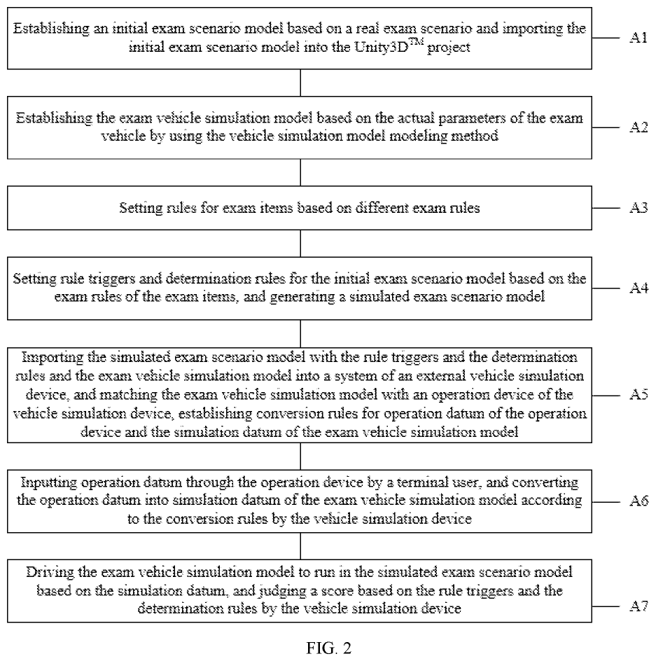

In an embodiment, as shown in FIG. 2, a vehicle simulation exam judgment method using an exam vehicle simulation model built by the vehicle simulation model modeling method of the embodiment 1 includes the following steps.
A1: an initial exam scenario model is established based on real exam scenarios and the initial exam scenario model is imported into the Unity3D™ project.

In this step, a real exam scenario is sampled using aerial modeling or oblique photography techniques, and Maya3D™ is used to process and optimize the sampling results to obtain an initial exam scenario model that is one-to-one with the real scenario.
A2: the vehicle model is established based on the actual parameters of the exam vehicle by using the vehicle simulation model modeling method.
A3: rules for exam items are set based on different exam rules.
A4: rule triggers and determination rules are set for the initial exam scenario model based on the exam rules of the exam items, and followed by generating a simulated exam scenario model.

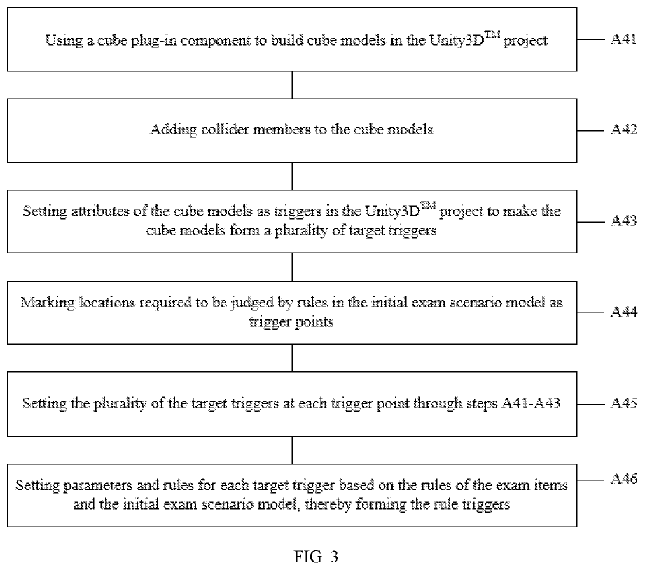

Specifically, as shown in FIG. 3, the step of setting the rule triggers and the determination rules are as follows.
A41: a cube plug-in component is used to build cube models in the Unity3D™ project.
A42: collider members are added to the cube models.
A43: attributes of the cube models are set as triggers in the Unity3D™ project to make the cube models form a plurality of target triggers.
A44: locations required to be judged by rules are marked in the initial exam scenario model as trigger points.
A45: the plurality of the target triggers are set at each of the trigger point through steps A41-A43. One of the target triggers is set at each of the start location and the end location, and one or more of the target triggers are set at the process location. The number of the target triggers to be set is determined based on the actual rules that need to be determined
A46: parameters and rules for each the rule trigger are set based on the rules of the exam items and the initial exam scenario model, thereby forming the rule triggers. The parameter rules include position datum and scale datum, which are used to set the size and position of the target triggers and determine whether the exam vehicle simulation model can encounter the rule triggers for rule judgment.

In a specific embodiment, such as the right angle turn item, it is necessary to use the right angle turn in the initial exam scenario model. Setting a rule trigger at the start position of a right angle turn as the starting trigger for the right angle turn item, and setting the parameters of the start trigger. The position datum are: x=−46.9, y=1.77, z=5.89, and the scale datum are: x=1.84, y=4.96, z=11.22. Moreover, setting the trigging rules for the rule trigger: determining whether to turn on the turn signal, setting the rule trigger at the end position of the turn as the end trigger for the right angle turn item, and setting the parameters of the end trigger. The position datum are x=3.6, y=4.4, z=30.2, and the scale datum are x=16.11, y=7.82, Z=1.8 and determining whether to turn off the turn signal, when the exam vehicle simulation model passes through the right angle bend and collides with the start trigger, the system triggers the callback ontrggerenter (Collider) method to provide feedback on the judgment result of the start trigger, when the exam vehicle simulation model leaves the right angle bend and collides with the end trigger, the system triggers the callback ontrggerenter (Collider) method to provide feedback on the judgment result of the end trigger.

A5: the rule triggers and the determination rules of the simulated exam scenario model and the vehicle model of the exam vehicle are imported into an external vehicle simulation device system, and the vehicle model is matched with operation equipment of the exam vehicle simulation model, followed by establishing conversion rules for operation datum of the operation equipment and the simulation datum of the exam vehicle simulation model.

A6: the operation datum are input through the operation equipment by the terminal user, and followed by converting the operation datum into the simulation datum of the exam vehicle simulation model according to the conversion rules by the vehicle simulation device.

In the embodiment 1, after the exam vehicle simulation model is imported into the vehicle simulation device, the operation datum can be converted into simulation datum corresponding to the parameters of the exam vehicle simulation model by operating external devices. When the exam vehicle obtains the corresponding simulation datum, the control function is called to drive the operation of the exam vehicle simulation model. It is worth noting that in this embodiment, the vehicle simulation device is any of the prior art, which has a complete simulation of the vehicle operation process and supports the Unity3D™ operating system.

A7: the exam vehicle simulation model is driven to run in the simulated exam scenario model based on the simulation datum, and followed by judging a score based on the rule triggers and the determination rules by the vehicle simulation device.

In the specific embodiment, the rule triggers include preset judgment rules and exam judgment rules. The preset judgment rules include speed limit rules, which specifically state that speed of the vehicle cannot exceed the specified speed; the rules for car lights, the usage of turn signals during turns and lane changes, are determined based on whether the turnsignal feedback from the exam vehicle simulation model is true; pressing the line rule, setting the rule trigger to indicate whether the collider on the exam vehicle simulation model has encountered or crossed the rule trigger, and providing feedback on the exam vehicle simulation model pressing the line when encountering or crossing the rule triggers; the flameout rule is that during the exam, the exam vehicle simulation model cannot be flameout. The judgment is based on the feedback of the start parameters of the exam vehicle simulation model as the starting vehicle state and the current speed feedback of the vehicle being greater than 0.

In the embodiment, other preset judgment rules are also included to determine whether the exam or vehicle is operating normally and in accordance with the rules.

The exam judgment rules include specific rules set according to exam items.

In the embodiment, for example, the exam content of subject three includes the passing of the school road item, and the criteria for passing the project are to lightly brake twice, and the speed cannot exceed 20 km/h. To achieve the determination of the two rules. At the beginning of the exam item, when the start trigger for the item judgment is encountered, the current speed of the simulated vehicle is obtained for each frame to determine whether the speed exceeds 20 km/h, when the speed exceeds 20 km/h, a prompt can pop up and the corresponding score can be deducted. In addition, the depth data of the brake pedal pressed in each frame should also be recorded. Specifically, at the beginning of the item, a temporary array should be established and the data should be written into it. After the end event of the item is triggered, the end trigger for the item judgment should be encountered. The data in the temporary array should be analyzed to determine twice whether a value of the data shows a trend of decreasing from large to small. When the value of the data does not appear, a prompt should be popped up and the corresponding score should be deducted. In the embodiment, it also includes the judgment of other exam related items, which need to be set according to the actual exam judgment content.

Obviously, the above embodiments of the disclosure are only examples to clearly illustrate the technical solution of the disclosure, and are not limited to specific embodiments of the disclosure. Any modifications, equivalent substitutions, and improvements made within the spirit and principles of the disclosure shall be included within the scope of protection of the disclosure.

What is claimed is:

1. A vehicle simulation model modeling method, comprising the following steps:
S1: obtaining actual parameters of an exam vehicle, and modeling, based on the actual parameters of the exam vehicle, to obtain a vehicle model;
S2: importing the vehicle model into a Unity3D™ project and adding vehicle assemblies to the vehicle model;
S3: setting vehicle start parameters, gear parameters, powertrain parameters, vehicle status parameters, engine parameters, and input coefficients for the vehicle model added with the vehicle assemblies; and
S4: obtaining an exam vehicle simulation model by setting a speed calculation method for the vehicle model according to the vehicle start parameters, the gear parameters, the powertrain parameters, the vehicle status parameters, the engine parameters, and the input coefficients obtained in step S3.

2. The vehicle simulation model modeling method as claimed in claim 1, wherein the vehicle assemblies in step S2 comprise wheel colliders, ordinary colliders, and rigid body components;
wherein the step of adding the wheel colliders comprises: adding the wheel colliders to wheels of the vehicle model in the Unity3D™ project;
wherein the step of adding the ordinary colliders comprises: adding four spherical colliders for a front of the vehicle model, a rear of the vehicle model, a left of the vehicle model, and a right of the vehicle model in the Unity3D™ project, as well as adding a square collider to a body of the vehicle model in the Unity3D™ project; and
wherein the step of adding the rigid body components comprises: adding the rigid body components to the vehicle model in the Unity3D™ project, and setting mass parameters based on the actual parameters of the exam vehicle; choosing an option of a use gravity of the rigid body components.

3. The vehicle simulation model modeling method as claimed in claim 1, wherein the vehicle start parameters comprise a power off status, a power on status, and a starting vehicle status; and/or
the gear parameters comprise manual gear parameters and automatic gear parameters; wherein the manual gear parameters comprise a neutral gear, a first gear, a second gear, a third gear, a fourth gear, a fifth gear, and a reverse gear, the automatic gear parameters comprise a parking gear, a forward gear, and a reverse gear; and/or
the powertrain parameters comprise a maximum wheel offset angle, a transmission efficiency, a brake pedal torque, and a braking curve; and/or
the vehicle status parameters comprise a gear ratio of each gear, a wheel torque of each gear, a minimum speed and a maximum speed of each gear, an idle speed of each gear and a foot brake torque of each gear; and/or
the engine parameters comprise a maximum engine speed, a minimum engine speed, a relationship curve between an engine speed and an output power, a curve speed ratio, a torque value of the idle speed, a speed increase limit, a speed decrease limit, a downshift deceleration acceleration, a conversion coefficient from an engine to wheel torques; and/or
the input coefficients comprise a steering wheel input, a clutch input, a brake input, a throttle input, and a handbrake switch.

4. The vehicle simulation model modeling method as claimed in claim 3, wherein the speed calculation method for the vehicle model comprises an applydrive method;
wherein a current gear is one of the gear parameters; a step of applying the applydrive method comprises: when a current vehicle speed is less than a minimum speed in the current gear, calculating a current torque value of the vehicle model, evenly distributing the current torque value of the vehicle model to driving wheels to obtain current forward torque values of the driving wheels, and then calculating a vehicle rigid speed based on the current forward torque values;
wherein the driving wheels are that actually drive a real vehicle forward; and
the vehicle rigid speed is a theoretical speed of the vehicle model.

5. The vehicle simulation model modeling method as claimed in claim 4, wherein the step of calculating the current torque value of the vehicle model comprises an equation as follows:
the current torque value of the vehicle model=a current torque value of an idle speed in a current gear×a current gear ratio in the current gear×the transmission efficiency×the clutch input+a current torque value of a current engine speed in the current gear×the throttle input× the clutch input×the transmission efficiency;
wherein the current torque value of the current engine speed is obtained based on engine parameters of the real vehicle.

6. The vehicle simulation model modeling method as claimed in claim 5, wherein the speed calculation method for the vehicle model further comprises a carspeed method;
wherein a step of applying the carspeed method comprises:
obtaining normalization of the vehicle rigid speed;
calculating a minimum speed limit in the current gear, wherein an equation of the minimum speed limit is as follows: the minimum speed limit in the current gear=(a maximum speed in the current gear−a minimum speed in the current gear)×the throttle input+the idle speed in the current gear;
when the vehicle rigid speed is greater than the maximum speed in the current gear, calculating a current speed of the vehicle model through an equation as follows: the current speed of the vehicle model=the maximum speed in the current gear×the normalization of the vehicle rigid speed; and then updating the vehicle rigid speed as the current speed of the vehicle model;
when the vehicle rigid speed is greater than the minimum speed limit in the current gear and less than the maximum speed in the current gear, obtaining an intermediate speed as speedVal through an equation as follows: the speedVal=the vehicle rigid speed−the downshift deceleration acceleration×time; the time is an interval from a last frame to a current frame in seconds;
when the speedVal is greater than 0, obtaining the current speed of the vehicle model through an equation as follows: the current speed of the vehicle model=the speedVal×the normalization of the vehicle rigid speed; and then updating the vehicle rigid speed as the current speed of the vehicle model; and
calculating a current standardized speed of the vehicle mode through an equation as follows: the current standardized speed=the current speed×3.6, and standardizing the current speed of the vehicle to kilometer per hour (km/h).

7. A vehicle simulation exam judgment method, comprising the following steps:
A1: establishing an initial exam scenario model based on a real exam scenario and importing the initial exam scenario model into the Unity3D™ project;
A2: establishing the exam vehicle simulation model based on the actual parameters of the exam vehicle by using the vehicle simulation model modeling method as claimed in claim 1;
A3: setting rules for exam items based on different exam rules;
A4: setting rule triggers and determination rules for the initial exam scenario model based on the exam rules of the exam items, and generating a simulated exam scenario model;
A5: importing the simulated exam scenario model with the rule triggers and the determination rules and the exam vehicle simulation model into a system of an external vehicle simulation device, and matching the exam vehicle simulation model with an operation device of the vehicle simulation device, establishing conversion rules for operation datum of the operation device and the simulation datum of the exam vehicle simulation model;
A6: inputting operation datum through the operation device by a terminal user, and converting the operation datum into simulation datum of the exam vehicle simulation model according to the conversion rules by the vehicle simulation device;
A7: driving the exam vehicle simulation model to run in the simulated exam scenario model based on the simulation datum, and judging a score based on the rule triggers and the determination rules by the vehicle simulation device.

8. The vehicle simulation exam judgment method as claimed in claim 7, wherein the step of establishing an initial exam scenario model based on a real exam scenario comprises:
sampling the real exam scenario through an aerial modeling or oblique photography techniques to obtain sampling results, and processing and optimizing the sampling results using Maya3D™ to obtain the initial exam scenario model that is consistent with an environment layout of the real exam scenarios.

9. The vehicle simulation exam judgment method as claimed in claim 7, wherein the step of setting the rule triggers comprises:
A41: using a cube plug-in component to build cube models in the Unity3D™ project;
A42: adding collider members to the cube models;
A43: setting attributes of the cube models as triggers in the Unity3D™ project to make the cube models form a plurality of target triggers;
A44: marking locations required to be judged by rules in the initial exam scenario model as trigger points;
A45: setting the plurality of the target triggers at each trigger point through steps A41-A43; and
A46: setting parameters and rules for each target trigger based on the rules of the exam items and the initial exam scenario model, thereby forming the rule triggers.

10. The vehicle simulation exam judgment method as claimed in claim 9, wherein the step of setting the plurality of the target triggers comprises: setting the target triggers at a start location, a process location, and an end location of rule determinations at each trigger point; and
setting one of the target triggers at each of the start location and the end location, and setting one or more of the target triggers at the process location.
